(19) United States
(12) Patent Application Publication
(10) Pub. No.: US 2008/0155136 A1
(43) Pub. Date: Jun. 26, 2008

(54) MEMORY CONTROLLER, COMPUTER, AND DATA READ METHOD

(76) Inventor: TOMONORI HISHINO, Tokyo (JP)

Correspondence Address: NEC CORPORATION OF AMERICA, 6535 N. STATE HWY 161, IRVING, TX, 75039, US

(21) Appl. No.: 11/960,231

(22) Filed: Dec. 19, 2007

(30) Foreign Application Priority Data
Dec. 22, 2006 (JP) 346709/2006

(51) Int. Cl. G06F 13/28

(52) U.S. Cl. 710/26

(57) ABSTRACT

A memory controller connected with a first memory module and a second memory module each holding the same data, which includes a command issuing unit and an output unit. The command issuing unit issues a read command so that a data read order for the first memory module is different from a data read order for the second memory module when data in an address range designated by a host device are read from the first memory module and the second memory module. The output unit that outputs the data in the address range to the host device.

### INCORPORATION BY REFERENCE

This application is based upon and claims the benefit of priority from Japanese patent application No. 2006-346709, filed on Dec. 22, 2006, the disclosure of which is incorporated herein in its entirety by reference.

### BACKGROUND OF THE INVENTION

1. Field of the Invention

The present invention relates to a technique for reading data from mirrored memories, and more particularly, to a technique for increasing data read speed.

2. Description of the Related Art

In recent years, there has been known a computer in which a memory mirroring function is installed to improve the availability thereof. An example of the above-mentioned computer is described in JP 2002-182972 A.

Memory mirroring is described as the following technique. That is, the same data is written into two memories to provide redundancy. When one of the memories causes an error and breaks the data, the data read from the other memory is used. Therefore, the loss of the data can be prevented by the memory mirroring.

Here, a related technique will be described. FIG. 7 shows an example of the computer having the memory mirroring function. Computer 200 includes central processing units (CPUs) 101a and 101b, CPU controller 102, I/O controller 103, memory controller 104, peripheral component interconnect (PCI) devices 105a, 105b, and 105c, and dual in-line memory modules (DIMMs) 106a, 106b, 106c, and 106d. Note that DIMMs 106a, 106b, 106c, and 106d are collectively referred to as “DIMM 106.”

Memory controller 104 is connected with CPU controller 102 through dedicated interface 111, and memory controller 104 is connected with DIMM 106 through memory control buses 107a and 107b and memory data buses 108a and 108b. Memory controller 104 performs the reading and writing of data from and into DIMM 106 in response to a memory access request from CPU controller 102.

FIG. 8 is a timing chart when memory controller 104 performs the burst reading of data whose burst length is set to eight words from DIMMs 106a and 106b.

Memory controller 104 outputs the same active command and the same read command to memory control buses 107a and 107b at times T10 and T11.

DIMM 106a and DIMM 106b output respective read data to memory data bus 108a and memory data bus 108b, respectively, at a time T12 after the output of the active command.

Memory controller 104 captures data from memory data buses 108a and 108b. At this time, an error correcting code (ECC) check is performed for error detection and error correction. When data read from one of memory data buses 108a and 108b includes an uncorrectable error, memory controller 104 uses data from the other of memory data buses 108a and 108b to output read data to CPU controller 102 at a time T13.

A time required for the data reading is equal to that when memory mirroring is not used irrespective of the presence or absence of the uncorrectable error.

### SUMMARY OF THE INVENTION

An exemplary object of the present invention is to provide a memory controller, a computer, and a data read method that are capable of shortening a time required to read data from memories without losing data redundancy resulting from memory mirroring.

In an exemplary embodiment, a memory controller connected with a first memory module and a second memory module each holding the same data, includes a command issuing unit that issues a read command so that a data read order for the first memory module is different from a data read order for the second memory module when data in an address range designated by a host device are read from the first memory module and the second memory module, and an output unit that outputs the data in the address range to the host device.

In an exemplary embodiment, a computer includes above-mentioned memory controller.

In an exemplary embodiment, a memory controller connected with a first memory module and a second memory module each holding the same data, includes a command issuing means for issuing a read command so that a data read order for the first memory module is different from a data read order for the second memory module when data in an address range designated by a host device are read from the first memory module and the second memory module, and an output means for outputting the data in the address range to the host device.

In an exemplary embodiment, a data read method of reading data from a first memory module and a second memory module each holding the same data, includes issuing a read command so that a data read order for the first memory module is different from a data read order for the second memory module, when a read instruction including designation of an address range is received from a host device, and outputting the data in the address range to the host device.

### BRIEF DESCRIPTION OF THE DRAWINGS

Exemplary features and advantages of the present invention will become apparent from the following detailed description when taken with the accompanying drawings in which:

FIG. 1 is an exemplary block diagram showing an information processing apparatus 20 in a first exemplary embodiment;

FIG. 2 is an exemplary block diagram showing a memory controller 4 of FIG. 1;

FIG. 3 is another exemplary block diagram showing the memory controller 4 of FIG. 1;

FIG. 4 is a timing chart showing exemplary timings of command sending and data reading when the memory controller 4 reads data from a DIMM 6;

FIG. 5 is another timing chart showing exemplary timings of command sending and data reading when the memory controller 4 reads data from the DIMM 6;

FIG. 6 is further another timing chart showing exemplary timings of command sending and data reading when the memory controller 4 reads data from the DIMM 6;

FIG. 7 is a block diagram showing an exemplary structure of a computer 200 having a memory mirroring function; and

FIG. 8 is a timing chart showing exemplary timings of command sending and data reading when a memory controller 104 reads data from a DIMM 106.

### DETAILED DESCRIPTION OF THE EXEMPLARY EMBODIMENTS

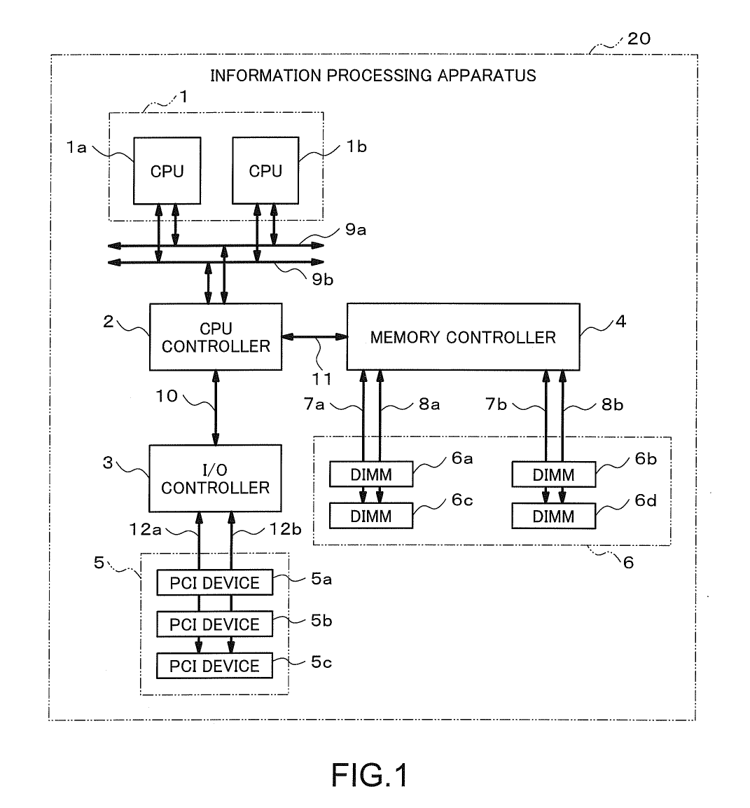

FIG. 1 is an exemplary block diagram showing an information processing apparatus 20 in a first exemplary embodiment. The information processing apparatus 20 is, for example, a server computer and includes CPUs 1a and 1b, a CPU controller 2, an I/O controller 3, a memory controller 4, PCI devices 5a, 5b, and 5c, and DIMMs 6a, 6b, 6c, and 6d. Note that the CPUs 1a and 1B are collectively referred to as “CPU 1,” the PCI devices 5a, 5b, and 5c are collectively referred to as “PCI device 5,” and DIMMs 6a, 6b, 6c, and 6d are collectively referred to as “DIMM 6.”

The CPU 1 and the CPU controller 2 are connected with each other through a CPU control bus 9a and a CPU data bus 9b. The CPU controller 2 and the I/O controller 3 are connected with each other through a dedicated bus 10. The CPU controller 2 and the memory controller 4 are connected with each other through a dedicated bus 11. The memory controller 4 is connected with the DIMMs 6a and 6c through a memory control bus 7a and a memory data bus 8a. The memory controller 4 is connected with the DIMMs 6b and 6d through a memory control bus 7b and a memory data bus 8b.

The CPU controller 2 transfers a memory access request from the CPU 1 or the I/O controller 3 to the memory controller 4. The CPU controller 2 transfers an I/O access request from the CPU 1 to the I/O controller 3.

The I/O controller 3 transfers the I/O access request from the CPU controller 2 to the PCI device 5. The I/O controller 3 transfers a memory access request from the PCI device 5 to the CPU controller 2.

The memory controller 4 performs the writing of data into the DIMM 6 in response to the memory access request from the CPU controller 2. At the time of writing data into the DIMM 6, an error correcting code (ECC) is added. At the time of reading, the ECC added at the time of writing is used to perform error detection on the read data and error correction thereon if possible.

When data are to be read from a pair of memory modules (for example, DIMMs 6a and 6b) which are mirrored, the memory controller 4 issues a read command so that the read order of data from one of the memory modules is different from the read order of data from the other of the memory modules.

The DIMM 6 includes, for example, a double data rate synchronous dynamic random access memory (DDR SDRAM). Memory mirroring is performed between the DIMMs 6a and 6b or between the DIMMs 6c and 6d, each of which holds the same data to which the ECC is added.

That is, above-mentioned one of the memory modules is DIMM 6a or DIMM 6c, and above-mentioned other of the memory modules is DIMMs 6b or DIMMs 6d. Moreover, DIMM 6a or DIMM 6c may be called the first memory module and DIMM 6b or DIMM 6d may be called the second memory module.

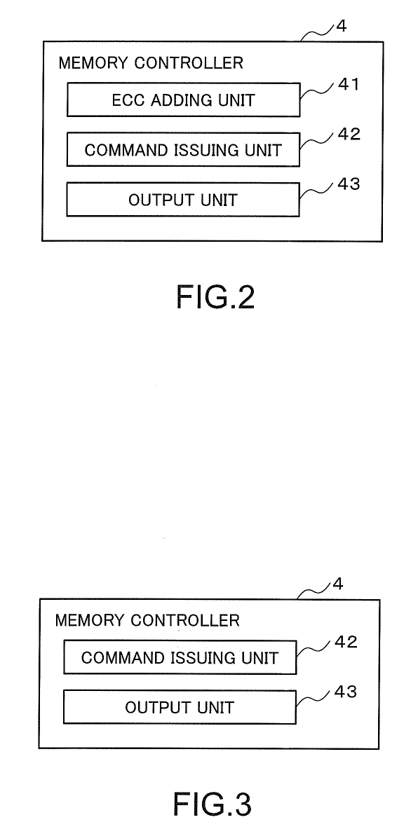

FIG. 2 is a block diagram showing an exemplary structure of the memory controller 4 of FIG. 1. The memory controller 4 includes an ECC adding unit 41, a command issuing unit 42, and an output unit 43. The ECC adding unit 41 receives write data from the CPU controller 2 to temporarily hold the write data and generates an ECC from the write data to add to the write data.

For example, when a data transfer width of the dedicated bus 11 is set to 32 bits, the ECC adding unit 41 receives write data of 32 bits (1 word) and generates an ECC of 7 bits to add the ECC to the write data, thereby obtaining data of 39 bits in total.

Then, the ECC adding unit 41 sends data added with the ECC (39 bits) to each of the memory data buses 8a and 8b.

Upon receiving a write request and an address from the CPU controller 2, the command issuing unit 42 instructs the writing to the same address of the pair of memory modules (for example, DIMMs 6a and 6b) through the memory control buses 7a and 7b.

Upon receiving, for example, an eight-word burst read request and an address (start address located in eight-word boundary) from the CPU controller 2, the command issuing unit 42 reads data from the pair of memory modules (for example, DIMMs 6a and 6b) which are mirrored. At this time, the command issuing unit 42 issues a command for reading words 0 to 7 in an address range designated to one of the memory modules (for example, DIMM 6a) in this order. In addition, the command issuing unit 42 issues a command for reading words 0 to 7 in an address range for the other of the memory modules (for example, DIMM 6b) in an order different from the above-mentioned order (for example, word order of 4 to 7 and 0 to 3).

The output unit 43 performs read data error detection on each word (for example, 39 bits including 7 bits of ECC) of data read from each of the pair of memory modules (for example, DIMMs 6a and 6b) which are mirrored. If possible, the output unit 43 performs read data error correction on each word. The error correction performed if possible is, for example, one-bit error correction.

The example is described in which the ECC adding unit 41 adds the ECC of 7 bits to the write data of 32 bits to obtain the data of 39 bits in total and writes the obtained data into the pair of memory modules. However, other examples can be employed. For example, the ECC adding unit 41 adds an ECC of eight bits to write data of 64 bits to obtain data of 72 bits in total as one word and writes the obtained data into the pair of memory modules. In such a case, the reading of data from the memory modules is performed in a unit of one word (72 bits).

Returning to FIG. 1, this exemplary embodiment will be described. A bus connection is made between the CPU 1 and the CPU controller 2 and between the memory controller 4 and the DIMM 6. Another connection method such as a point-to-point connection method may be employed. While the CPU controller 2, the I/O controller 3, and the memory controller 4 are shown as separate components, the CPU controller 2, the I/O controller 3, and the memory controller 4 may be integrated or contained in the CPU 1.

Further, the DIMM 6 to be used may be a DDR2 SDRAM or another RAM instead of the DDR SDRAM. The number of the DIMMs 6 may be any multiple of two. A type of the memory modules may be a type other than the DIMM.

Next, the operation of the information processing apparatus 20 will be described.

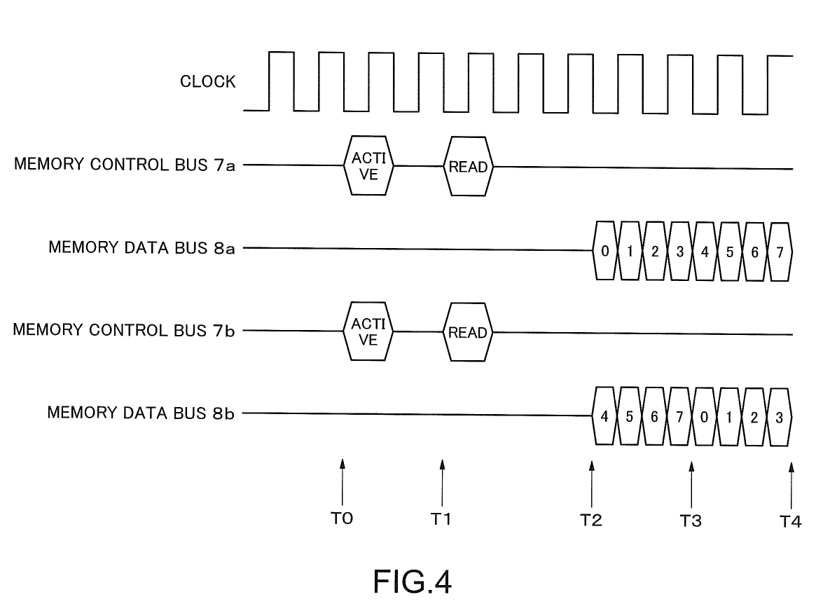

FIG. 4 is a timing chart showing exemplary timings of command sending and data reading when the memory controller 4 burst-reads data whose burst length is set to eight words from the DIMMs 6a and 6b.

At a time T0, the command issuing unit 42 of the memory controller 4 outputs active commands to the memory control buses 7a and 7b. Note that the command issuing unit 42 asserts chip select signals for the DIMMs 6a and 6b and negates chip select signals for the DIMMs 6c and 6d. Therefore, only the DIMMs 6a and 6b are changed to an active state.

After the output of the active commands, the lapse of a row address strobe (RAS) to column address strobe (CAS) delay time specified for the DIMM 6 is waited. At a time T1, the command issuing unit 42 of memory controller 4 outputs read commands to the memory control buses 7a and 7b. In the first exemplary embodiment, the RAS-to-CAS delay time is set to two clock cycles.

Here, the command issuing unit 42 designates the read command for the memory control bus 7a so that data are output in an order of 0, 1, 2, 3, 4, 5, 6, and 7 corresponding to least significant three bits of a read address (word address).

In addition, the command issuing unit 42 designates the read command for memory control bus 7b so that data are output in an order of 4, 5, 6, 7, 0, 1, 2, and 3, corresponding to least significant three bits of a read address (word address). Therefore, the DIMMs 6a and 6b are changed to a read state.

After the read commands are output from the command issuing unit 42, when a CAS latency time specified for the DIMM 6 is elapsed and at a time T2, the DIMMs 6a and 6b output data to the memory data buses 8a and 8b. In this exemplary embodiment, the CAS latency time is set to three clock cycles.

The memory controller 4 captures data from the memory data buses 8a and 8b. At this time, the memory controller 4 performs an ECC check for error detection and error correction.

That is, the output unit 43 of memory controller 4 simultaneously captures data from the memory data buses 8a and 8b. At this time, the output unit 43 also performs an ECC check on the captured respective data for each word to execute error detection and error correction. When there is no uncorrectable error, all data which should be read from the DIMM 6 before a time T3 are held in the output unit 43. At the time T3, the output unit 43 outputs read data to the CPU controller 2.

For example, before the time T3, respective words in which it is determined by error detection that there is no error or on which error correction is performed are temporarily held in buffer registers (not shown) included in the output unit 43. At the time T3, the respective words are output to the CPU controller 2 together with a response signal.

Upon receiving the response signal, the CPU controller 2 can perform data reception control even when a clock cycle is small because data sending at a predetermined interval (1 clock cycle or ½ clock cycles) is ensured.

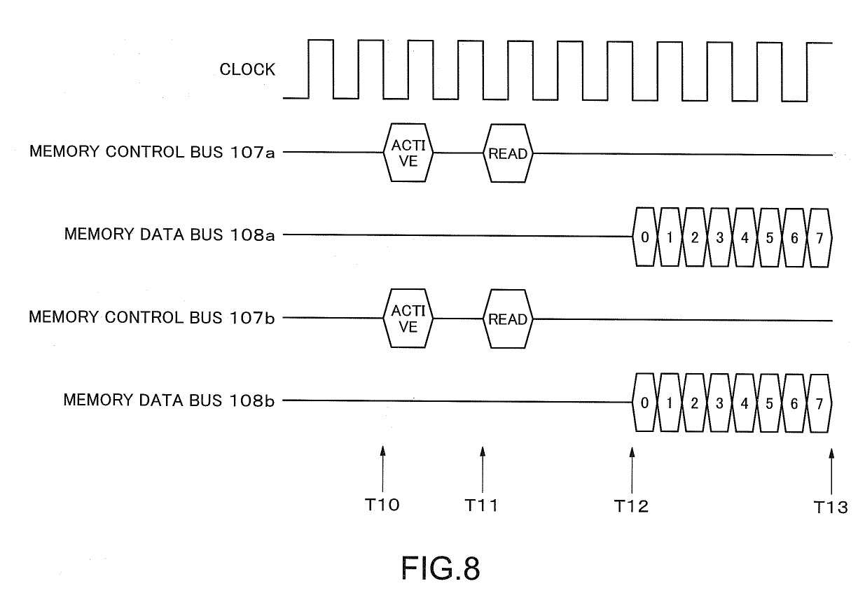

Therefore, when the first exemplary embodiment is compared with the related art shown in FIG. 8, a period between a time when data starts to be output and a time when all data designated by the CPU controller 2 are held in the memory controller 4 in the first exemplary embodiment is half of that in the related art shown in FIG. 8.

When data captured from the memory data bus 8a includes an uncorrectable error, the output unit 43 captures data from the memory data bus 8b before a time T4. At the time T4, the output unit 43 outputs read data to the CPU controller 2.

Next, another operation example of the information processing apparatus 20 will be described.

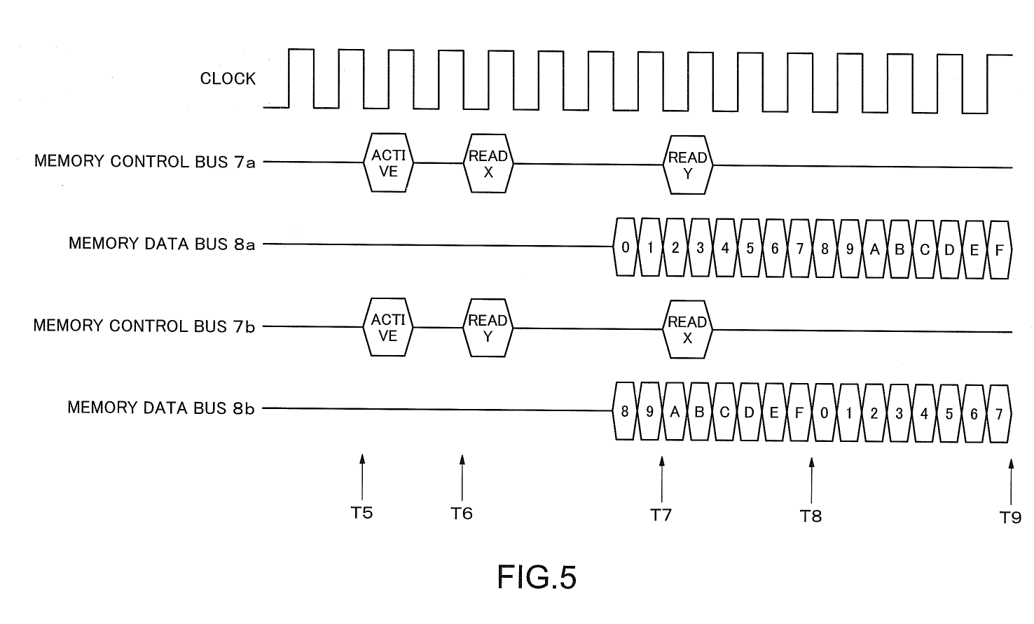

FIG. 5 is a timing chart showing exemplary timings of command sending and data reading when the memory controller 4 burst-reads data whose burst length is set to eight words from the DIMMs 6a and 6b at two addresses, an address X and an address Y.

Here, the address range (8 words) specified in Address X and the address range (8 words) specified in Address Y are continuous.

The operations at times T5 and T6 are identical to those in the exemplary embodiment as shown in FIG. 4. Assume that an address designated by the read command for the memory control bus 7a is the address X and an address designated by the read command for the memory control bus 7b is the address Y. In this exemplary embodiment, a data output order in the address range designated by the memory control bus 7a is identical to that by the memory control bus 7b.

After first read commands are output from the command issuing unit 42, the lapse of await time (four clock cycles in this exemplary embodiment) when the memory data buses 8a and 8b are not competitive is waited. At a time T7, the command issuing unit 42 outputs second read commands to the memory control buses 7a and 7b. Assume that, in the command issuing unit 42, an address designated by the read command for the memory control bus 7a is the address Y and an address designated by the read command for the memory control bus 7b is the address X.

After the respective read commands are output from the command issuing unit 42, when the CAS latency time is elapsed, the DIMMs 6a and 6b output data to the memory data buses 8a and 8b. In the first exemplary embodiment, the CAS latency time is set to three clock cycles.

The output unit 43 simultaneously captures data from the memory data buses 8a and 8b. At this time, the output unit 43 also performs an ECC check on the captured respective data in a unit of word to execute error detection and error correction. When there is no uncorrectable error, all data which should be read from the DIMM 6 before a time T8 are held in output unit 43. At the time T8, the output unit 43 outputs read data to the CPU controller 2.

Therefore, the output unit 43 outputs data in a designated range to the host device (CPU controller 2) in half of the time for reading data from the DIMMs 6a and 6b in the same order.

When data captured from the memory data bus 8a includes an uncorrectable error, the output unit 43 captures data from memory data bus 8b before a time T9. At the time T9, the output unit 43 outputs read data to the CPU controller 2.

Next, a further operation example of the information processing apparatus 20 will be described.

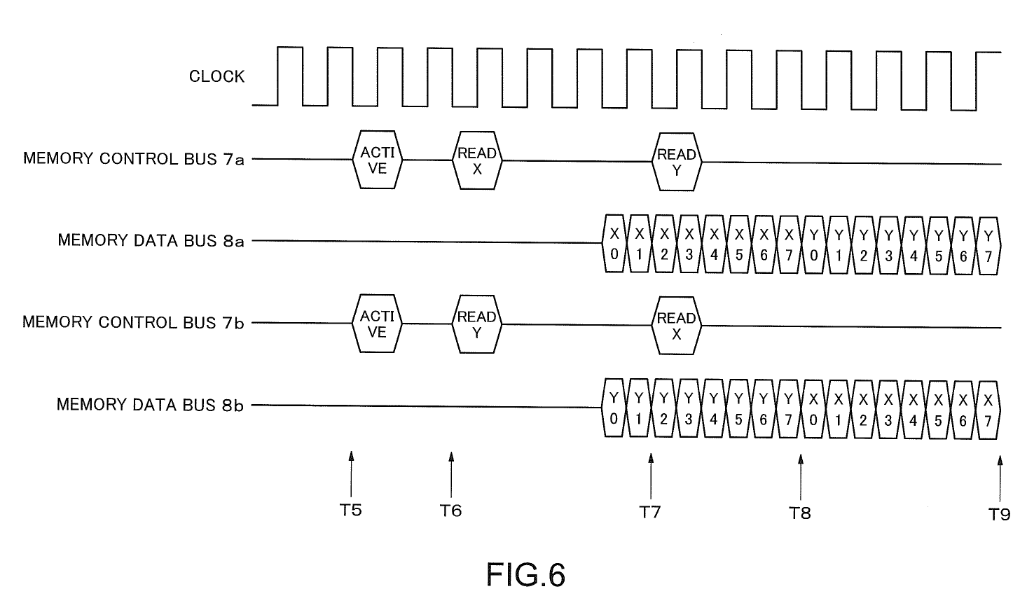

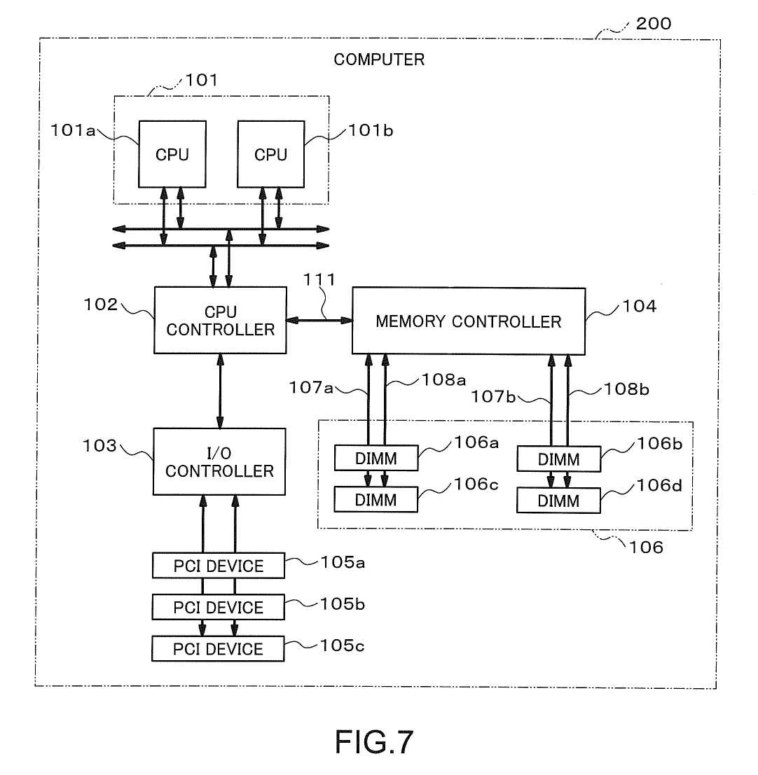

FIG. 6 is the timing chart showing exemplary timings of command sending and data reading when the memory controller 4 burst-reads data whose burst length is set to eight words from the DIMMs 6a and 6b at two addresses, an address X and an address Y.

However, the address range (8 Ward) specified by address X and address range (8 Ward) specified by address Y are discontinuous. That is, address X and address Y have a difference which exceeds 8 Ward. The operation except the above is identical to that in FIG. 5.

Next, another exemplary structure of the memory controller 4 will be described.

FIG. 3 is another exemplary block diagram showing the memory controller 4 of FIG. 1. The memory controller 4 of FIG. 3 includes the command issuing unit 42 and the output unit 43. Unlike the memory controller 4 of FIG. 2, the memory controller 4 of FIG. 3 does not include the ECC adding unit 41. According to the memory controller 4 of FIG. 3, a time required to read data from memories without losing data redundancy resulting from memory mirroring can be shortened.

Next, an effect in the first exemplary embodiment will be described.

The memory controller 4 issues the read commands so that the data read order is changed between the two memory modules. The two memory modules simultaneously output data in respective designated orders. As a result, the memory controller 4 can hold data in a range designated by the host device in a shorter time than the time in which data are read from the two memory modules in the same order.

Next, other exemplary embodiments will be described.

According to a second exemplary embodiment, when an address range is a single continuous range, read commands may be issued by a memory controller so that an address of data read from one of memory modules at a certain time is shifted from an address of data read from the other of the memory modules at the certain time by ½ of a length of the (memory) address range. Therefore, the memory controller holds data in a range designated by a host device in half the time for reading data from the two memory modules in the same order.

According to a third exemplary embodiment, a read command for one of memory modules may be issued by a memory controller so that data are read in an order from the start of an address range to the end thereof, and a read command for the other of the memory modules may be issued by the memory controller so that data are read in an order from the middle of the range to the end thereof and then in an order from the start of the range to a position immediately before the middle thereof.

According to a fourth exemplary embodiment, when an address range includes two continuous ranges, a read command for one of memory modules may be issued by a memory controller so that data are read in an order from the start of one of the two ranges to the end thereof and then in an order from the start of the other of the two ranges to the end thereof, and a read command for the other of the memory modules may be issued by the memory controller so that data are read in an order from the start of the other of the two ranges to the end thereof and then in an order from the start of the one of the two ranges to the end thereof.

According to a fifth exemplary embodiment, when an address range includes two ranges which are discontinuous, a read command may be issued by the memory controller like the above.

Therefore, the memory controller holds all data in a range designated by a host device in half the time for reading data from the two memory modules in the same order.

Next, exemplary advantages of the information processing apparatus 20 will be described.

According to the information processing apparatus 20, the memory controller 4 issues the read commands for the two DIMMs which are mirrored to provide the different data read orders. Therefore, the time required to read data from the DIMM 6 can be shortened.

When data read from the DIMM 6a or 6c includes an uncorrectable error after all read data are held in the memory controller 4, data is read from the DIMM 6b or 6d, so data redundancy resulting from memory mirroring is not lost.

Further, the memory mirroring function requires a memory capacity two times that of a normal case and thus becomes higher in cost. There is no advantage except for the case where memory data includes an uncorrectable error. Therefore, up to now, it may be difficult to employ the memory mirroring function except for a part of systems which requires high availability. However, according to the exemplary embodiments, such problems are solved.

The previous description of exemplary embodiments is provided to enable a person skilled in the art to make and use the present invention. Moreover, various modifications to those exemplary embodiments will be readily apparent to those skilled in the art, and the generic principles and dedicated examples defined herein may be applied to other exemplary embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. A memory controller connected with a first memory module and a second memory module each holding the same data, comprising:
a command issuing unit that issues a read command so that a data read order for the first memory module is different from a data read order for the second memory module when data in an address range designated by a host device are read from the first memory module and the second memory module; and
an output unit that outputs the data in the address range to the host device.

2. A memory controller according to claim 1, wherein the output unit determines, when all the data in the address range are read from the first memory module and the second memory module in response to the read command, a result obtained by error checking based on an error correcting code included in the data, and outputs the data in the address range to the host device when the result shows no uncorrectable error.

3. A memory controller according to claim 1, wherein, when the address range is a single continuous range, the command issuing unit issues a read command so that an address of data read from the first memory module at a certain time is shifted from an address of data read from the second memory module at the certain time by ½ of a length of the address range.

4. A memory controller according to claim 3, wherein the command issuing unit issues a read command for the first memory module so that data are read in an order from a start of the address range to an end thereof, and issues a read command for the second memory module so that data are read in an order from a middle of the address range to the end thereof, and then in an order from the start of the address range to a position immediately before the middle thereof.

5. A memory controller according to claim 2, wherein, when the address range includes a first range and a second range which are continuous, the command issuing unit issues a read command for the first memory module so that data are read in an order from a start of the first range to an end thereof, and then in an order from a start of the second range to an end thereof, and issues a read command for the second memory module so that data are read in an order from the start of the second range to the end thereof, and then in an order from the start of the first range to the end thereof.

6. A memory controller according to claim 2, wherein, when the address range includes a first range and a second range which are discontinuous, the command issuing unit issues a read command for the first memory module so that data are read in an order from a start of the first range to an end thereof, and then in an order from a start of the second range to an end thereof, and issues a read command for the second memory module so that data are read in an order from the start of the second range to the end thereof, and then in an order from the start of the first range to the end thereof.

7. A memory controller connected with a first memory module and a second memory module each holding the same data, comprising:
a command issuing means for issuing a read command so that a data read order for the first memory module is different from a data read order for the second memory module when data in an address range designated by a host device are read from the first memory module and the second memory module; and
an output means for outputting the data in the address range to the host device.

8. A computer comprising the memory controller according to claim 1.

9. A data read method of reading data from a first memory module and a second memory module each holding the same data, comprising:
issuing a read command so that a data read order for the first memory module is different from a data read order for the second memory module, when a read instruction including designation of an address range is received from a host device; and
outputting the data in the address range to the host device.

10. A data read method according to claim 9, wherein the outputting of the data in the address range to the host device comprises:
determining, when all the data in the address range are read from the first memory module and the second memory module in response to the read command, a result obtained by error checking based on an error correcting code included in the data; and
outputting the data in the address range to the host device when the result shows no uncorrectable error.

11. A data read method according to claim 9, wherein the issuing of the read command comprises, when the address range is a single continuous range, issuing a read command so that an address of data read from the first memory module at a certain time is shifted from an address of data read from the second memory module at the certain time by ½ of a length of the address range.

12. A data read method according to claim 11, wherein the issuing of the read command comprises:
issuing a read command for the first memory module so that data are read in an order from a start of the address range to an end thereof; and
issuing a read command for the second memory module so that data are read in an order from a middle of the address range to the end thereof and then in an order from the start of the address range to a position immediately before the middle thereof.

13. A data read method according to claim 10, wherein the issuing of the read command comprises, when the address range includes a first range and a second range which are continuous:
issuing a read command for the first memory module so that data are read in an order from a start of the first range to an end thereof and then in an order from a start of the second range to an end thereof; and
issuing a read command for the second memory module so that data are read in an order from the start of the second range to the end thereof and then in an order from the start of the first range to the end thereof.

14. A data read method according to claim 10, wherein the issuing of the read command comprises, when the address range includes a first range and a second range which are discontinuous:
issuing a read command for the first memory module so that data are read in an order from a start of the first range to an end thereof and then in an order from a start of the second range to an end thereof; and
issuing a read command for the second memory module so that data are read in an order from the start of the second range to the end thereof and then in an order from the start of the first range to the end thereof.
